(19) United States
(12) Patent Application Publication
(10) Pub. No.: US 2026/0016123 A1
(43) Pub. Date: Jan. 15, 2026

(54) OVERWRAPPED COMPOSITE VESSELS FOR THE STORAGE AND TRANSMISSION OF GASES

(71) Applicant: BRAINDRIP, LLC, Jacksonville, FL (US)

(72) Inventor: Kent Weisenberg, Jacksonville, FL (US)

(73) Assignee: BRAINDRIP, LLC, Jacksonville, FL (US)

(21) Appl. No.: 19/265,225

(22) Filed: Jul. 10, 2025

Related U.S. Application Data
(60) Provisional application No. 63/669,334, filed on Jul. 10, 2024.

(51) Int. Cl. F17C 1/10; F17C 1/16

(52) U.S. Cl. CPC F17C 1/10; F17C 1/16; F17C 2203/0604; F17C 2203/067; F17C 2209/232

(57) ABSTRACT

A tubular composite for storing and/or transporting a gas includes a tubular sealing/barrier layer for forming a gas diffusion resistant containment for the gas, and a helical overwrap coupled to the tubular layer. The helical overwrap includes a reinforcement element wrapped about the tubular layer at a winding angle with respect to a longitudinal axis of the tubular layer that is greater than or equal to 70°. Systems and methods of fabricating the tubular composite include a camera for capturing images of the overwrap as the reinforcement element is being wrapped about a tubular layer, and a controller structured and configured for analyzing the images and controlling a winder, an applicator apparatus or both the winder and the applicator apparatus to adjust the winding angle and/or an axial spacing of the reinforcement element as it is wrapped about the tubular layer based on the analysis of the images.

### CROSS REFERENCE TO RELATED APPLICATIONS

This application claims priority to U.S. Provisional Patent Application Ser. No. 63/669,334, filed on Jul. 10, 2024, and titled “Overwrapped Composite Vessels for the Storage and Transmission of Gases,” the disclosure of which is incorporated herein by reference.

### FIELD

Disclosed herein are helically overwound sealed vessels with improved strength and efficiency. Also disclosed are related methods of storage and method of fabrication.

### BACKGROUND

The use of sealed vessels is widespread in industry for storage and transmission of gases. Ideally, a sealed vessel used to contain a gas is completely impermeable to the gas, and leakage of gas from the vessel is entirely eliminated. Storage of hydrogen is particularly susceptible to leakage, due to the small size of the diatomic molecule (H₂), particularly compared to hydrocarbons. The diatomic hydrogen molecule is significantly smaller than even methane, the simplest hydrocarbon. Aside from loss of product, permeation of hydrogen from a sealed vessel can potentially create hazard, due to its large flammable concentration range, low ignition energy, high flame velocity, and limited flame emissions in the visible spectrum. For this reason, materials and methods are sought to reduce hydrogen permeation from sealed vessels, particularly for extended periods of time.

Composite overwrapped pressure vessels and composite reinforced polymer pipe products have widespread use in a range of industry applications and offer many advantages over traditional vessels and pipes, such as reduced weight and better corrosion resistance. The base material's primary purpose in the composite assembly is to form the containment, and it is often composed of polymers such as medium density polyethylene (MDPE), high density polyethylene (HDPE), polyaramids (PA), or even aluminum in the case of Type III vessels. The construction of these vessels and pipe products follows with the use of carbon or other high-strength fiber reinforcement on the base tubular vessel to attain the desired final mechanical properties and primary pressure rating design criteria.

One opportunity for advancement in the manufacturing of composite vessels lies in the application of the fiber reinforcement fabrics that are wound on the exterior surface. Unidirectional or bidirectional fibers are both commonly employed to provide reinforcement of the vessel structure, providing strength in the axial and radial/hoop directions. For bidirectional fiber applications, an inherent compromise exists in the performance for both axial and radial reinforcement effect, as optimization of one is detrimental to the other. For example, a high winding angle for bidirectional fabrics will provide a relative improvement in the radial reinforcement but this will reduce the effectiveness in the axial direction. For this reason, relatively low winding angles are often used to achieve a compromise in performance. In addition, both unidirectional and bidirectional fibers are limited in their overall strength due to their construction and application, with a significant amount of fiber tensile strength being lost due to non-uniform tensions on the fiber filaments. The performance of reinforcements are also sensitive to the precision and repeatability of application. To overcome these limitations, additional fiber layers or thicknesses are needed to achieve the desired properties, significantly increasing the cost of the final product.

Many manufacturing methods can be used to apply reinforcement fibers on composite vessels. A common method, shown in FIG. 1, utilizes continuous rovings 5, which are pulled through a comb device 10 and then passed through a bath 15 where they are saturated with a curable resin. A laminated reinforcement is created as the rovings are then pulled through a nip roller device 20. Thereafter, the reinforcement is applied to the vessel 30 as it is mounted on a rotating mandrel 25, providing bidirectional reinforcement. As noted able, to the extent that the rovings are provided in a helical manner, the helix angle is about 55° or less.

There remains a need to improve the performance and reliability of fabrics for the reinforcement of pressure vessels.

### BRIEF SUMMARY

Accordingly, provided herein is a tubular composite comprising a helical overwrap, wherein the helical angle of the overwrap is greater than or equal to 75°.

Also provided herein is a method of storing a fluid, the method comprising the step of filling a tubular composite comprising a helical overwrap with the fluid, wherein the helical angle of the overwrap is greater than or equal to 75°.

Also provided herein is a method for manufacturing a tubular composite, the method comprising the step of applying a helical overwrap to an exterior surface of an incomplete tubular composite, wherein the helical angle of the overwrap is greater than or equal to 75°.

Also disclosed herein is a method for using computer vision to ensure independent reinforcement application accuracy and precision. This method provides high reliability and cost optimization of the final product. Other devices that can provide imaging and feedback control, such as laser profilers, are within the intended scope of this disclosure, although for many applications the high accuracy and “trainability” of the computer vision system disclosed herein may be of particular value.

### BRIEF DESCRIPTION OF THE DRAWINGS

A full understanding of the invention can be gained from the following description of the preferred embodiments when read in conjunction with the accompanying drawings in which:

FIG. 1 depicts prior art machinery for overwrapping a tubular composite;

FIGS. 2A and 2B depict a micro-rope material that may be utilized in the disclosed concept;

FIG. 2C depicts application of the micro-rope material of FIGS. 2A and 2B during on-site manufacturing;

FIGS. 3A and B depict a geometric model used for ANSYS analysis according to the disclosed concept in horizontal projection and corresponding cross-section, respectively;

FIGS. 4A and B depict the geometric model used for ANSYS analysis according to the disclosed concept in perspective corresponding cross-section, respectively;

FIGS. 5A-5H depicts winding schemes used for ANSYS analysis according to the disclosed concept in various winding angles;

FIGS. 6A-6H depict total deformation [in] for various winding angles;

FIGS. 7A-7H depict sealing layer von-Mises stress [psi] for various winding angles;

FIGS. 8A-8H depict fiber maximum principal stress [psi] for various winding angles;

FIG. 9 shows the effect of radial winding angle (horizontal axis) on (a) sealing layer von-Mises stress (left axis: stress in psi x 10) (b) fiber maximum principal stress (left axis: stress in psi) (c) maximum deformation (right axis: maximum deformation in inches);

FIGS. 10A and B show FEA models for a baseline vessel and an independent reinforcement vessel, respectively;

FIGS. 11A and B depict heat plots of total deformation [in] for a baseline vessel and an independent reinforcement vessel, respectively;

FIGS. 12A and B depict heat plots of radial deformation [in] for a baseline vessel and an independent reinforcement vessel, respectively;

FIGS. 13A and B depict heat plots of von-Mises stress [psi] for a baseline vessel and an independent reinforcement vessel, respectively;

FIGS. 14A and B depict heat plots of maximum principal stress [psi] on reinforcement fibers for a baseline vessel and an independent reinforcement vessel, respectively;

FIGS. 15A-15C show FEA models of composite pipes with various radial fiber gaps;

FIGS. 16A-16C show equivalent stresses on sealing materials with various radial fiber gaps;

FIGS. 17A-17C show maximum principal stresses on sealing materials with various radial fiber gaps; and

FIG. 18 is a schematic diagram of a computer vision system according to an aspect of the disclosed concept.

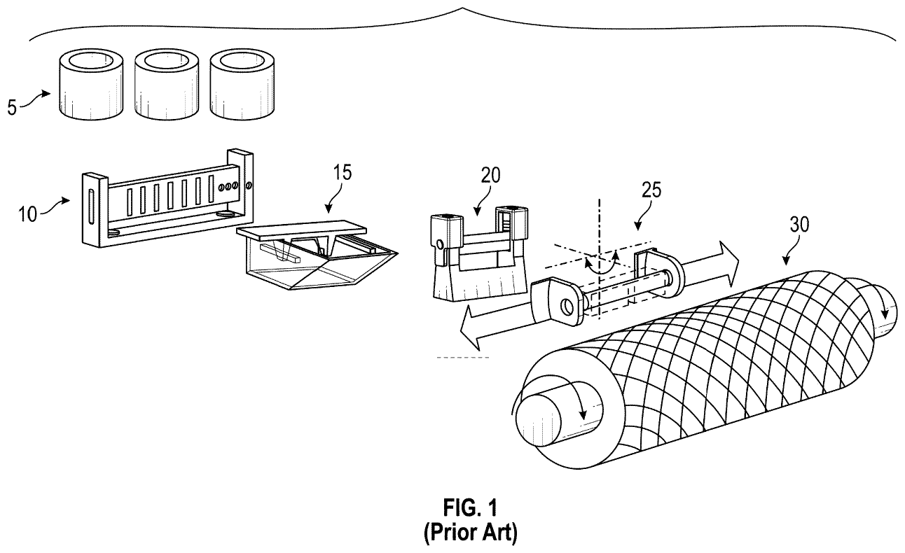

### DETAILED DESCRIPTION OF PREFERRED EMBODIMENTS

The lengthwise application of ribbons of this material to a tubular composite can provide excellent resistance to axial stress; however, such strips of ribbon material provide negligible resistance to circumferential stress, also referred to as hoop stress. For this reason, a second layer of this ribbon material can be applied in a helical direction, thereby providing a bidirectional tubular composite. Helices of such ribbon material can be used to counteract hoop stress. The helix angle can be expected to determine the ability of such a ribbon to provide resistance to forces in the axial and the hoop directions, and the choice of a helix angle thus represents a compromise between the strength requirements in either direction, and the cost in providing the ribbon material. Increasing the helical angle, i.e., applying the ribbons further from collinearity with the tubular composite axis, can improve the resistance to hoop stress. However, the amount of material, per unit length, required for the helical overwrap will increase dramatically with increased helical angle-in fact, as expected from considerations of geometry and trigonometry, the calculation breaks down and diverges to an infinite amount of material as the helical angle approaches 90°. A shallower angle of 55° is typically used for manufacturing contemporary bidirectional tubular composites. To date, the variation of helical angle on the strength of a resulting tubular composite has not been studied in detail. It is therefore not clear whether the optimum helical angle for a tubular composite has been properly identified.

Provided in this disclosure are the results of finite element analysis (“FEA”) calculations performed on model overwrapped pressure vessels. These results will demonstrate that, in contrast to conventional thought, overwrap helical angles that are much larger than the standard 55° are preferable for providing strength to overwrapped pressure vessels.

Accordingly, provided herein is a tubular composite comprising a helical overwrap, wherein:

the helical angle of the overwrap is greater than or equal to 75°.

In some embodiments, the helical angle of the overwrap is greater than or equal to 80°. In some embodiments, the helical angle of the overwrap is greater than or equal to 85°.

In some embodiments, the helical angle of the overwrap is less than 90°.

In some embodiments, the helical angle of the overwrap is less than or equal to 89°, optionally less than or equal to 88°, optionally less than or equal to 86°, optionally less than or equal to 84°, optionally less than or equal to 82°, optionally less than or equal to 80°.

In some embodiments, the overwrap comprises a plurality of helically oriented strips. In some embodiments, at least 90% of the strips do not overlap, optionally at least 95%, optionally at least 98%, optionally at least 99%. In some embodiments, the median gap between non-overlapping strips is 0.5 inch or smaller, optionally 0.25 inch or smaller, optionally 0.125 inch or smaller.

Also provided herein is a method of storing a fluid, the method comprising the step of filling a tubular composite comprising a helical overwrap with the fluid, wherein the helical angle of the overwrap is greater than or equal to 75°, optionally greater than or equal to 80°, optionally greater than or equal to 85°.

Also provided herein is a method for manufacturing a tubular composite, the method comprising the step of applying a helical overwrap to an exterior surface of an incomplete tubular composite, wherein the helical angle of the overwrap is greater than or equal to 75°, optionally greater than or equal to 80°, optionally greater than or equal to 85°.

Also provided herein is a method for manufacturing a tubular composite, the method comprising the steps of:
providing a winder capable of applying a plurality of helically oriented reinforcing strips to a cylindrical layer;
fabricating an innermost cylindrical layer, with the innermost cylindrical layer becoming the outermost cylindrical layer of an incomplete tubular composite; and
performing one or more iterations of the following steps:
   fabricating a new hoop reinforcing cylindrical layer comprising a plurality of helically oriented reinforcing strips on the outer surface of the current outermost cylindrical layer of the incomplete tubular composite, such that:
      the existing outermost cylindrical layer thereby becomes an inner layer of the tubular composite; and
      the new cylindrical layer thereby becomes the current outermost cylindrical layer of the tubular composite;
wherein the helical angle of at least one of the one or more helically wound cylindrical layers is greater than or equal to 75°.

In some embodiments, the method further comprises one or more iterations of the following step:
fabricating a new axial reinforcing cylindrical layer comprising axially oriented reinforcing strips on the outer surface of the current outermost cylindrical layer of the incomplete tubular composite, such that:
   the existing outermost cylindrical layer thereby becomes an inner layer of the tubular composite; and
   the new cylindrical layer thereby becomes the current outermost cylindrical layer of the tubular composite.

In some embodiments, each of the cylindrical layers is progressively formed from a distal end of the tubular composite to a proximal end of the tubular composite. In some embodiments, fabrication of at least one helically wound cylindrical layer is initiated before fabrication of an inner cylindrical layer is completed. In some embodiments, fabrication of each of the one or more helically wound cylindrical layers is initiated before fabrication of an inner cylindrical layer is completed.

In some embodiments, the innermost cylindrical layer is fabricated on the surface of a mechanical forming mandrel. In some embodiments, the innermost cylindrical layer is fabricated on the surface of a cantilevered mechanical forming mandrel.

Also provided herein is a method for manufacturing a tubular composite, the method comprising the steps of:

providing a winder as disclosed herein;
providing a mechanical forming mandrel having a fixed, upstream end and a cantilevered, downstream end;
forming a first circular leading end of a first cylindrical layer from a first feedstock on the surface of the mandrel at a first location near the fixed end, with the outer surface of the first cylindrical layer becoming the outermost cylindrical layer of an incomplete tubular composite;
advancing the first circular leading end towards the cantilevered end;
performing one or more iterations of the following steps:
   forming a new circular leading end of a new hoop reinforcing cylindrical layer on the outer surface of the advancing outermost cylindrical layer of the incomplete tubular composite at a downstream location, with the circular leading end comprising termini of each of a plurality of helically oriented reinforcing strips; and
   fabricating a new hoop reinforcing cylindrical layer from the plurality of helically oriented reinforcing strips on the outer surface of the advancing outermost cylindrical layer behind the advancing new circular leading end, the new cylindrical layer thereby advancing with the inner layers towards the cantilevered end, such that:
      the existing outermost cylindrical layer thereby becomes an inner layer of the tubular composite; and
      the new cylindrical layer thereby becomes the current outermost cylindrical layer of the tubular composite;
      wherein the helical angle of at least one of the one or more helically wound cylindrical layers is greater than or equal to 75°, optionally greater than or equal to 80°, optionally greater than or equal to 85°.

In some embodiments, the method further comprises one or more iterations of the following step:
forming a new circular leading end of a new axial reinforcing cylindrical layer on the outer surface of the advancing outermost cylindrical layer of the incomplete tubular composite at a downstream location, with the circular leading end comprising termini of a plurality of axially oriented reinforcing strips; and
fabricating a new axial reinforcing cylindrical layer from the plurality of axially oriented reinforcing strips on the outer surface of the advancing outermost cylindrical layer behind the advancing new circular leading end, the new cylindrical layer thereby advancing with the inner layers towards the cantilevered end, such that:
   the existing outermost cylindrical layer thereby becomes an inner layer of the tubular composite; and
   the new cylindrical layer thereby becomes the current outermost cylindrical layer of the tubular composite.

In some embodiments, the step of fabricating a new hoop reinforcing cylindrical layer provides a contiguous cylindrical layer, excepting one or more flaws, each chosen from a gap or an overlap, each located at a seam between adjacent helically oriented reinforcing strips. In some embodiments, the step of fabricating a new hoop reinforcing cylindrical layer provides a contiguous cylindrical layer, excepting one or more gaps, each located at a seam between adjacent helically oriented reinforcing strips. In some embodiments, the step of fabricating a new hoop reinforcing cylindrical layer provides a contiguous cylindrical layer, excepting one or more overlaps, each located at a seam between adjacent helically oriented reinforcing strips. In some embodiments, the step of fabricating a new hoop reinforcing cylindrical layer provides a contiguous cylindrical layer.

In some embodiments, the method further comprises the steps of:
providing a computer vision system as disclosed herein;
positioning the computer vision system so as to observe an outermost cylindrical layer of an incomplete tubular composite;
during a step of fabricating a new hoop reinforcing cylindrical layer:
   monitoring the seams between adjacent helically oriented reinforcing strips;
   continuously monitoring seams between adjacent helically oriented reinforcing strips for the appearance of flaws; and
   upon detection of a flaw, adjusting, as needed the fabrication of the new hoop reinforcing cylindrical layer to reduce the size of, or eliminate, the flaw.

Also provided herein is a winder capable of applying a plurality of helically oriented reinforcing strips to a cylindrical layer. In some embodiments, the winder further comprises a computer interface. In some embodiments, the winder is capable of adjusting the geometry of at each of the plurality of helically oriented reinforcing strips. In some embodiments, the winder is capable of adjusting the seam between adjacent helically oriented reinforcing strips. In some embodiments, the winder is capable of decreasing the lateral space between adjoining edges of adjacent helically oriented reinforcing strips, thereby removing gaps. In some embodiments, the winder is capable of increasing the lateral space between adjoining edges of adjacent helically oriented reinforcing strips, thereby removing overlaps.

Also provided herein is a computer vision system, the system comprising:
a high-resolution video camera; and
a computer capable of:
   accepting video input from the high-resolution video camera; and
   directing commands to the computer interface of the winder;
wherein the computer vision system is capable, during a process of fabricating a new hoop reinforcing cylindrical layer, of:
   observing seams between adjacent helically oriented reinforcing strips in the new hoop reinforcing cylindrical layer;
   continuously monitoring seams between adjacent helically oriented reinforcing strips for the appearance of flaws; and
   upon detection of a flaw:
      calculating one or more winder operations that would serve to reduce the size of, or eliminate, the flaw; and
      commanding the winder to perform the one or more winder operations, thereby reducing the size of, or eliminating, the flaw.

In some embodiments, the computer vision system is capable of commanding the winder to decrease the lateral space between adjoining edges of adjacent helically oriented reinforcing strips, thereby reducing the size of, or eliminating, a gap. In some embodiments, the computer vision system is capable of commanding the winder to increase the lateral space between adjoining edges of adjacent helically oriented reinforcing strips, thereby reducing the size of, or eliminating, an overlap.

Also provided herein is a method for manufacturing a tubular composite, the method comprising the steps of:
providing a winder as disclosed herein;
providing a computer vision system as disclosed herein;
fabricating a new hoop reinforcing cylindrical layer comprising a plurality of helically oriented reinforcing strips on the outer surface of a cylindrical layer of an incomplete tubular composite;
during the step of fabricating a new hoop reinforcing cylindrical layer:
   monitoring the seams between adjacent helically oriented reinforcing strips;
   continuously monitoring seams between adjacent helically oriented reinforcing strips for the appearance of flaws;
   upon detection of a flaw, adjusting, as needed the fabrication of the new hoop reinforcing cylindrical layer to reduce the size of, or eliminate, the flaw.

Disclosed herein are studies directed to the design and performance of polymer lined composite vessels comprising unidirectional micro-rope fiber reinforcement tapes applied independently in the axial and radial directions. The effects of micro-rope fiber reinforcement are investigated through Finite Element Analysis (FEA) simulations. In addition, the impact of fiber winding angle selection and reinforcement orientation on the sealing or barrier material structure is also characterized. FEA simulations are then employed for the optimized axial and radial reinforcement configuration to compare the effects of this reinforcement approach with the conventional reinforcement winding method.

Conventional reinforcement fibers used for overwrapping pressure vessels are typically coated with resin or other epoxy materials to create prepreg fibers or fabrics before application. Fibers can also be utilized to form either unidirectional or bidirectional fabrics, which are then applied as reinforcements. Each of these methods has its own set of limitations.

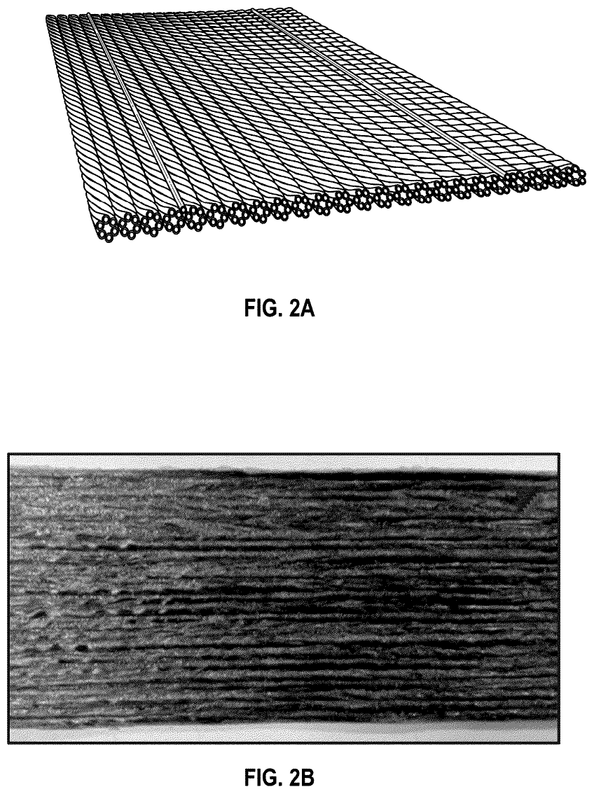

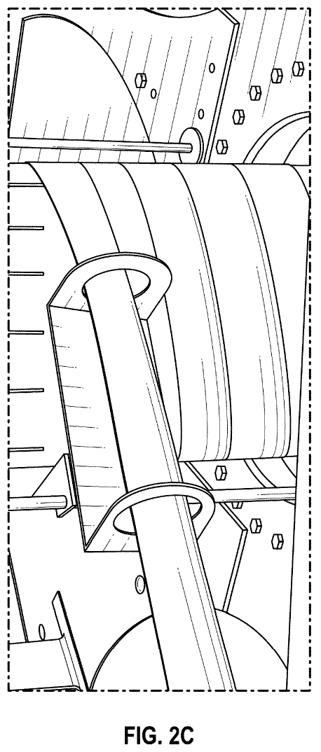

A novel form of reinforcement tape comprised of twisted fiber micro-ropes has been developed. A conceptual drawing of the micro-rope tape with embedded sensors is shown in FIG. 2A. The micro-rope reinforcement is crafted from twisted carbon fiber tows which are then bound into tape form using polyethylene. Each micro-rope consists of a single fiber tow or a few tows, where the filaments are impregnated with polyethylene and then twisted into a rounded rope under specific torsion. By combining and bonding multiple ropes, a flat tape profile is created to serve as the final reinforcement product. Depicted in FIG. 2B is a finished micro-rope tape product. An apparatus for applying this radial reinforcement during an on-site manufacturing process is depicted in FIG. 2C.

Typically, fiber strength increases at a decreasing rate as the volume of the applied material increases, due to failures originating from defects or weak points, such as non-uniform lengths of inadequately sized filaments. This predominately occurs in untwisted bidirectional fabrics where small inconsistencies in the winding processes cause inconsistent tensile stress. In contrast to untwisted fibers or fabrics, the twisted carbon fiber micro-rope exhibits a significantly lower dependence on fiber sizing effects and provides a conservative 50% higher average tensile strength as shown in Table 1. This performance gain is attributed to the higher shear bonding strength of the twisted structure within the rope. The enhanced shear bond strength renders the weakest and typically shortest fiber strands less susceptible to tensile loads. As the higher shear bond effectively transfers more load from the weakest strands to the surrounding ones, uneven tensile stress in the overall structure is minimized. In addition, an increase in the elongation at break also occurs for the micro-rope.

TABLE 1
Tensile test data for traditional reinforcement
fiber and micro-rope fiber tows

| | Breaking | Elongation |
|---|---|---|
| Fiber Form | Load (lbs) | at break (%) |
| Raw untwisted tow | 360 | 1.1 |
| micro-rope twisted tow | 670 | 1.42 |
| 5 untwisted tows combined | 1750 | 1.1 |
| 5 micro-rope twisted tows | 3382 | 1.35 |
| combined | | |

Due to these characteristics, micro-rope tape products as described herein can function as final reinforcement solutions without requiring additional bonding materials for fiber saturation and curing. This notably streamlines the manufacturing process and reduces costs. The lower stiffness and more pliable structure of polyethylene bonding materials compared to epoxy resins impart extreme flexibility to these tape products. This flexibility enables them to conform to complex shapes when wrapping around composite vessel surfaces which facilitates intricate design possibilities for composite vessels and tanks. In addition, the enhanced flexibility also eliminates the development of microcracks that are often an initiating failure mode when rigid bonding materials are used. Consequently, the developed micro-rope tape proves advantageous for high-pressure composite vessel and tank applications subject to high impact loading conditions.

Additional benefits of micro-rope tape products as described herein are its pre-application storability, ease of application, and compatibility with embedded sensors such as fiber optic cables. The integration of embedded sensors provides a synergistic advantage to the composite vessel, with the micro-rope providing structural continuity and protection to the sensors, while the sensors provide continuous health monitoring of the composite structure. When integrating the micro-rope tape into an intelligently designed composite vessel product, it is expected that the increased mechanical properties will achieve either a savings of over 50% the reinforcement material weight and costs or provide over twice the pressure rating under the same amount of reinforcement materials. These improvements represent a significant advancement in the composite vessel industry.

### EXAMPLE 1

### FEA of Helically Wound Vessels

To evaluate the effects of radial winding angle on the stress and deformation characteristics of composite vessels in the hoop direction with and without the addition of the novel micro-rope tape, finite element analysis (FEA) models of representative vessels were created and analyzed. Analysis using the finite element method (FEM) involves subdividing a large system into discrete parts, i.e., finite elements, thereby making tractable computational problems which would otherwise be infeasible or extremely time consuming, e.g. simultaneous analytical solution of several partial differential equations. FEA uses numerical methods to provide approximate solutions to these differential equations and related boundary conditions.

Finite element analysis is often used in engineering to estimate properties such as stress, vibration, fatigue, deformation and structural failure, heat transfer, kinematics, flow, and heat transfer.

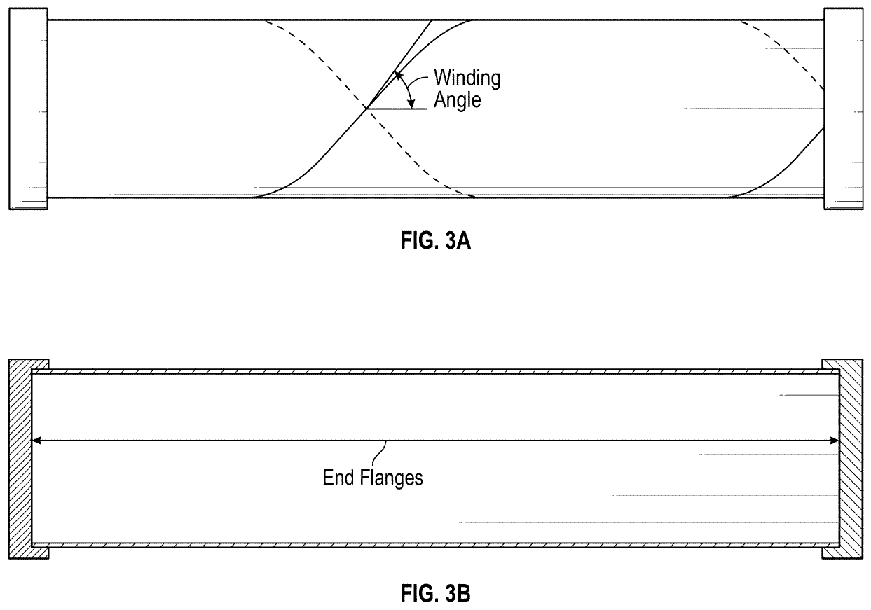

ANSYS Composite PrePost (ACP) was utilized to create a series of vessel simulations. FIG. 3A displays the geometric model of the vessel and its end flanges built in ANSYS. The exterior surface of the sealing/barrier material is reinforced with a radial and contra-radial layer of unidirectional fiber fabrics. Steel flanges are affixed to both ends of the vessel, and the fiber winding angle is depicted in the figure. The vessel has an outside diameter of 16 inches, length of 72 inches, and a sealing material thickness of 0.25 inches. Each layer of fiber fabric has a material thickness of 0.042 inches. The winding angle is superimposed on this drawing, with the limiting cases of 0° corresponding to lengthwise windings, and 90° corresponding to a circumferential winding, i.e. no helical progression down the cylinder.

FIG. 3B depicts a cross section of the geometric model. End flanges are affixed to either end of the cylindrical model.

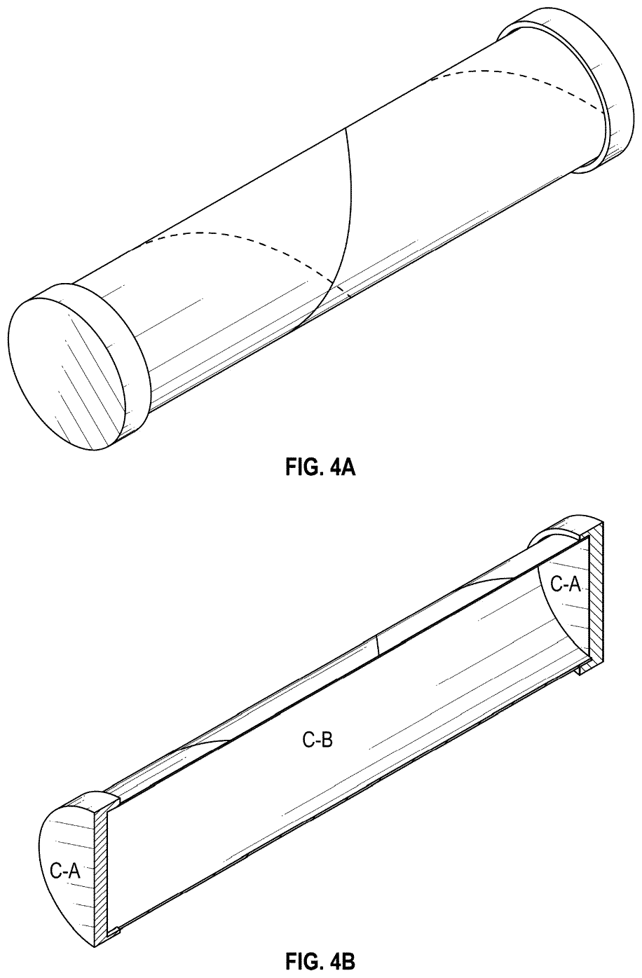

FIG. 4A displays a projection of the geometric model of the vessel, including both the radial and contra-radial helical windings.

For the simulations, both ends of the steel flanges are constrained as fixed supports, labeled C-A in FIG. 4B, while a pressure boundary condition of 1000 psi was applied to all interior surfaces and labeled C-B in FIG. 4B. Additionally, all components within the models are connected through bonded connections at their contact surfaces.

The simulations were generated through the combination of Static Structural and ACP modules.

Select mechanical properties input into the ANSYS model for a micro-rope tape reinforcement and HDPE sealing/barrier layer are provided in Tables 2 and 3, respectively. The unique x-direction corresponds to the cylinder length, with the y- and z-directions arbitrarily chosen in radial directions.

TABLE 2
Carbon Fiber Reinforcement Input Properties
for Radial Winding Evaluation in ANSYS

| | |
|---|---|
| Density [kg/m³] | 1439.4 |
| Ply Type | Regular |

| | X | Y | Z |
|---|---|---|---|
| Orthotropic Elasticity: | 1.9048E+7 | 10000 | 10000 |
| Young's Modulus [psi] | | | |
| Orthotropic Stress Limits: | 3.0E+5 | 200 | 200 |
| Tensile [psi] | | | |
| Orthotropic Stress Limits: | −3.0E+5 | −200 | −200 |
| Compressive [psi] | | | |

| | YZ | XZ | XY |
|---|---|---|---|
| Orthotropic Elasticity: | 0.42 | 0.25 | 0.25 |
| Poisson's Ratio | | | |
| Orthotropic Elasticity: | 6000 | 2.0E+6 | 2.0E+6 |
| Shear Modulus [psi] | | | |
| Orthotropic Stress Limits: | 100 | 10000 | 10000 |
| Shear [psi] | | | |
| Tsai-Wu Constants: | −1 | −1 | −1 |
| Coupling Efficiency | | | |

TABLE 3
MDPE Sealing/Barrier Layer Input Properties
for Radial Winding Evaluation in ANSYS

| | |
|---|---|
| Density [kg/m³] | 941.12 |
| Isentropic Elasticity | Derive from Young's |
| | Modulus |
| Isentropic Elasticity: Young's Modulus [psi] | 1.321E+5 |
| Isentropic Elasticity: Poisson's Ratio | 0.42 |
| Isentropic Elasticity: Bulk Modulus [Pa] | 1.8975E+9 |
| Isentropic Elasticity: Shear Modulus [Pa] | 3.2070E+8 |
| Tensile Yield Strength [psi] | 3000 |
| Compressive Yield Strength [psi] | 3000 |

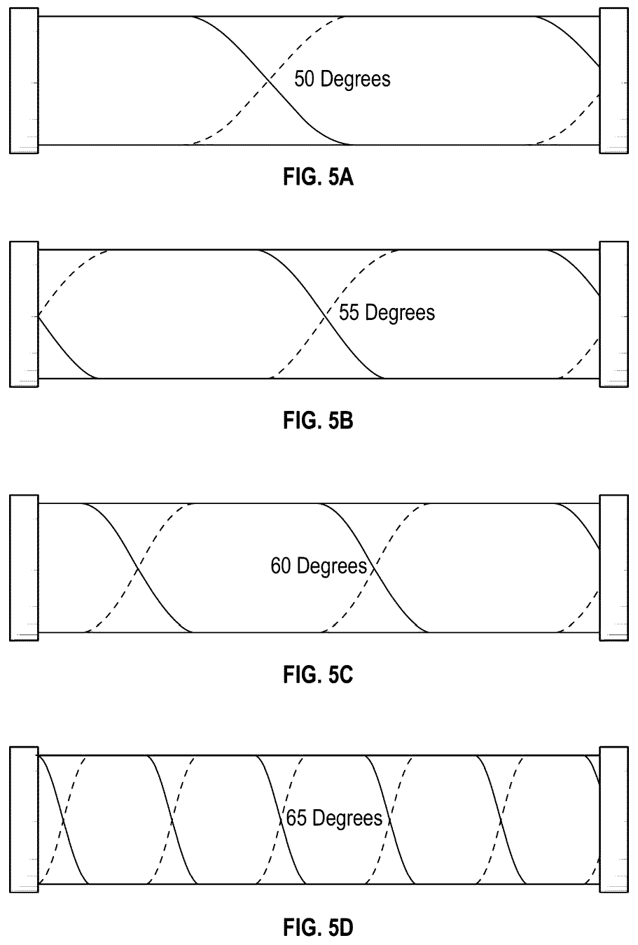

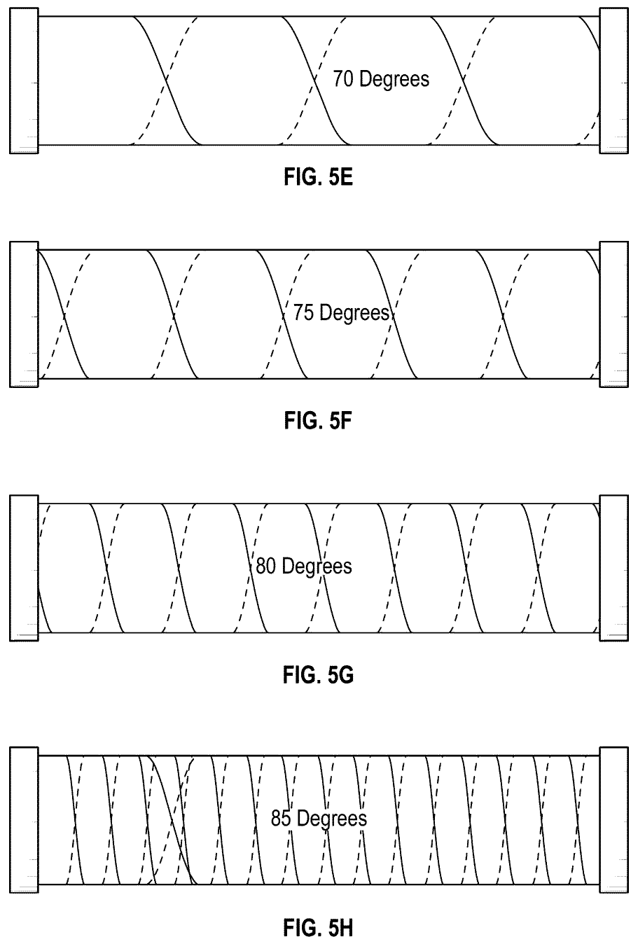

The unidirectional fiber fabric exhibits orthotropic material properties, with fiber filaments oriented along the X direction, and fabric width and thickness along the Y and Z directions. The sealing/barrier material is composed of medium density polyethylene (MDPE) with hydrogen diffusion resistant polymer layered coextrusion, and demonstrates isotropic material properties. The vessel flanges are assigned default structural steel material properties. Eight separate tubular composite vessel radial winding angles were used for the study, starting at 50° and ending at 85° in 5° increments. Images of the individual vessels and their radial winding angles are provided in FIGS. 5A-5H.

Alternative materials for the sealing/barrier layer described herein include polyaramids (PA) or aluminum.

FEA simulation results of the tubular composite vessel using micro-rope reinforcement applied through radial winding show a remarkable impact of winding angle on the deformation and stresses experienced by the vessel.

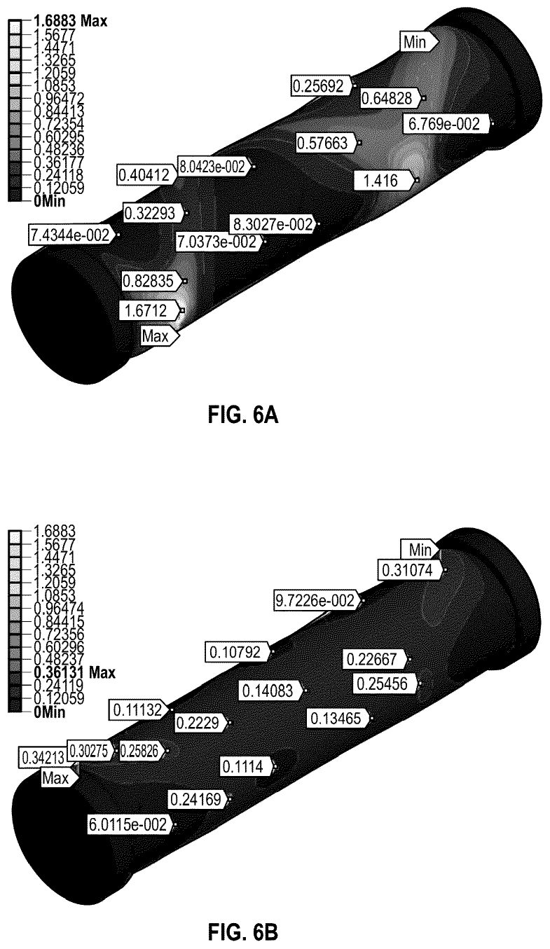

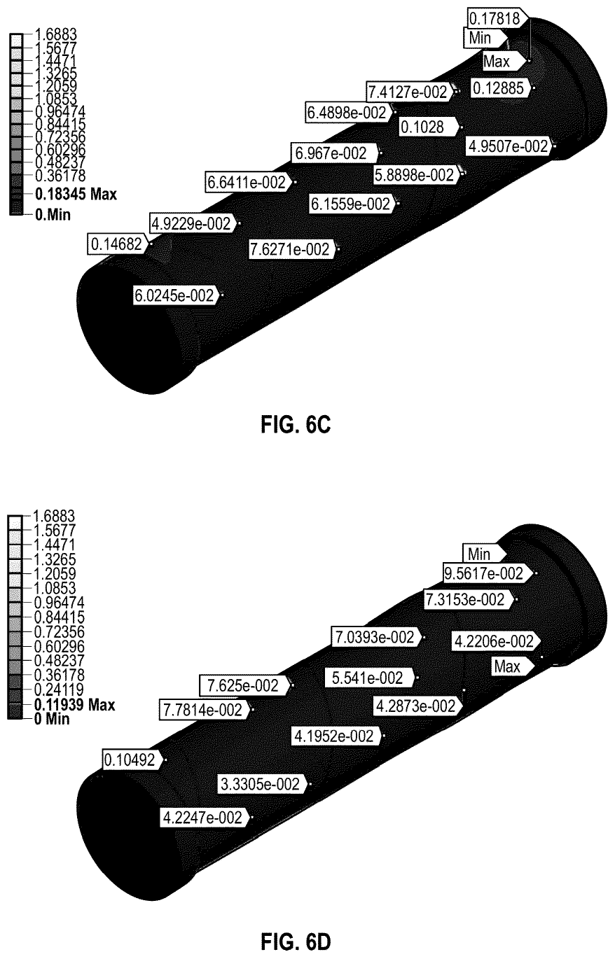

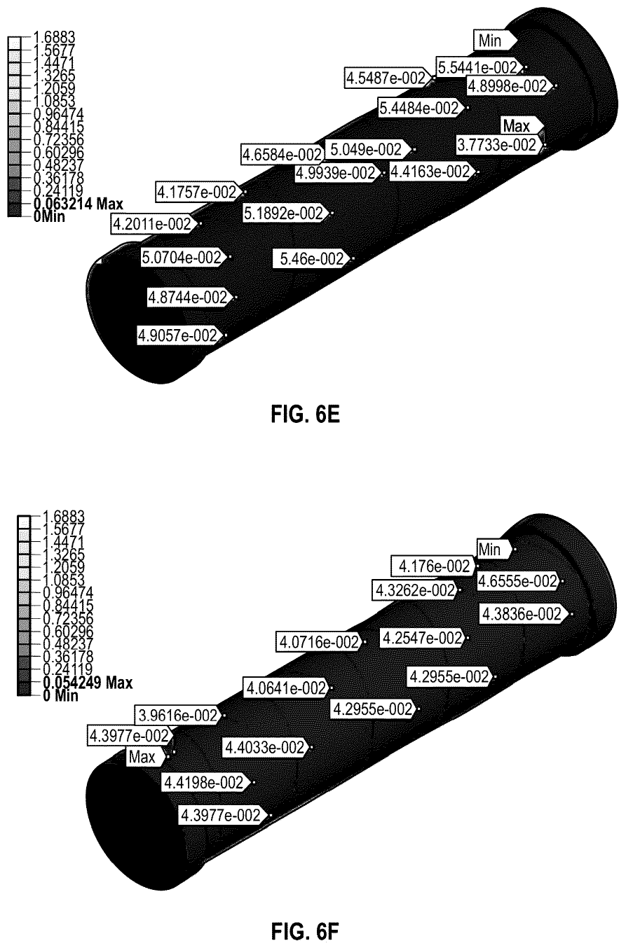

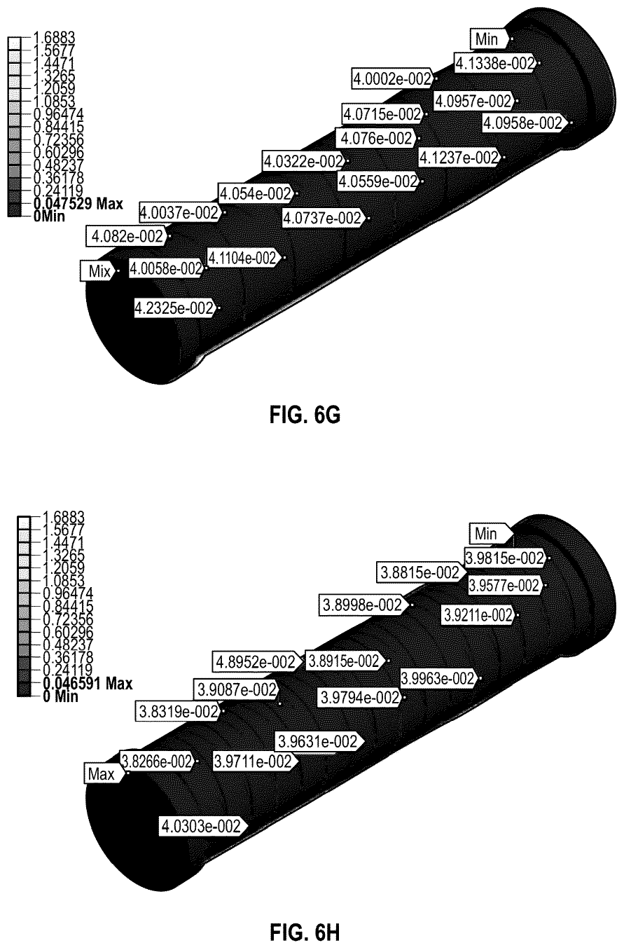

Provided in FIGS. 6A-6H are heat plots depicting total deformation [in] for winding angles of (a) 50°, (b) 55°, (c) 60°, (d) 65°, (e) 70°, (f) 75°, (g) 80°, and (h) 85°.

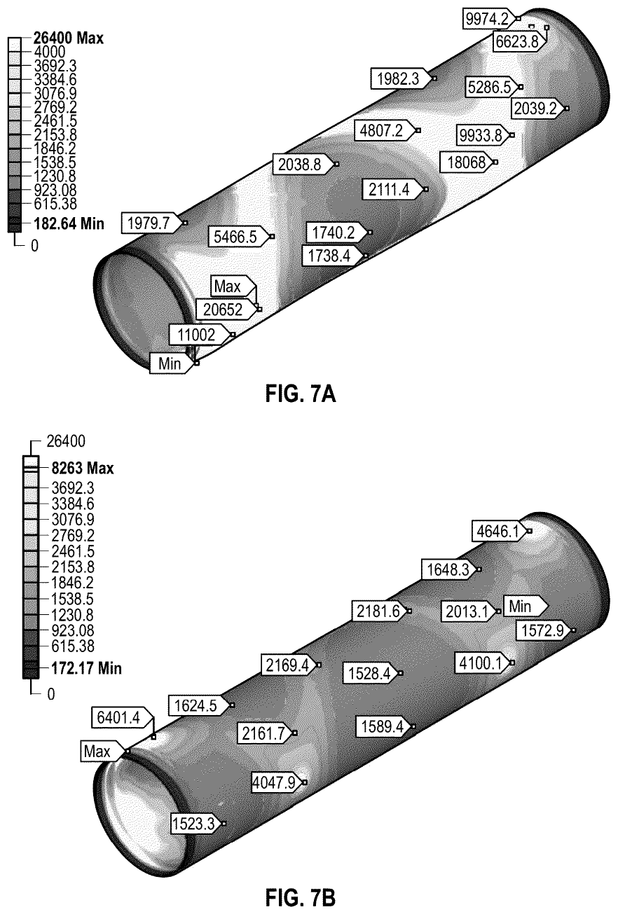

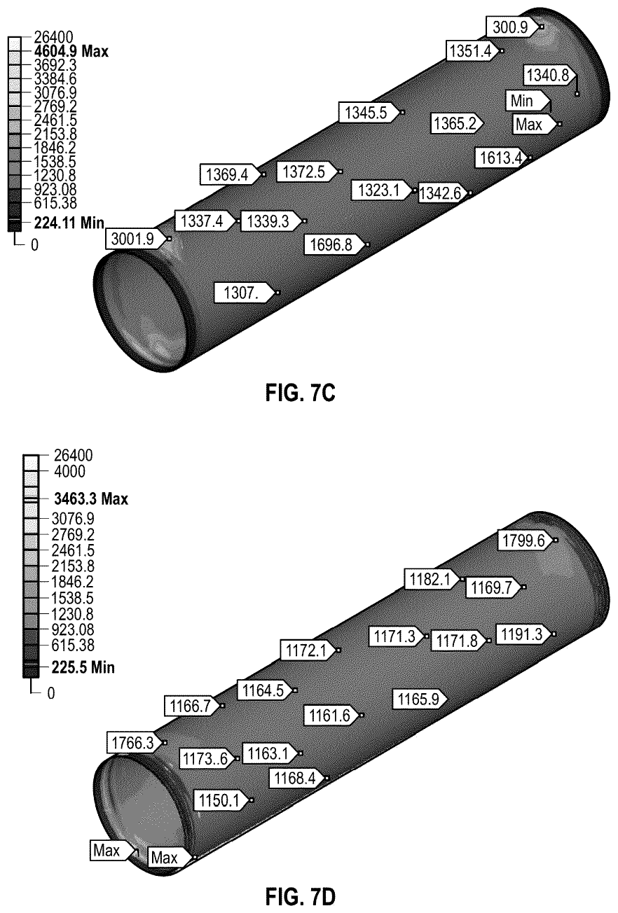

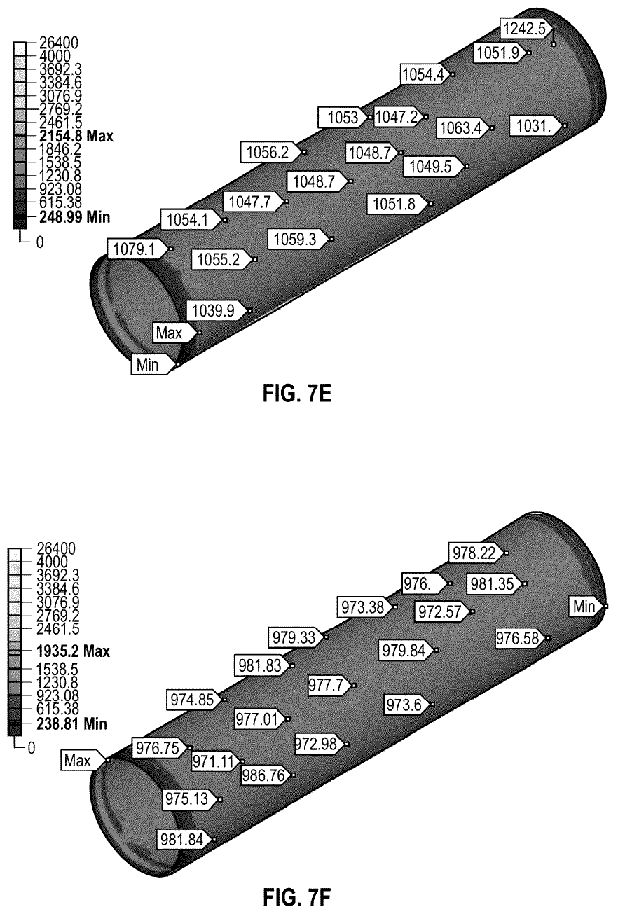

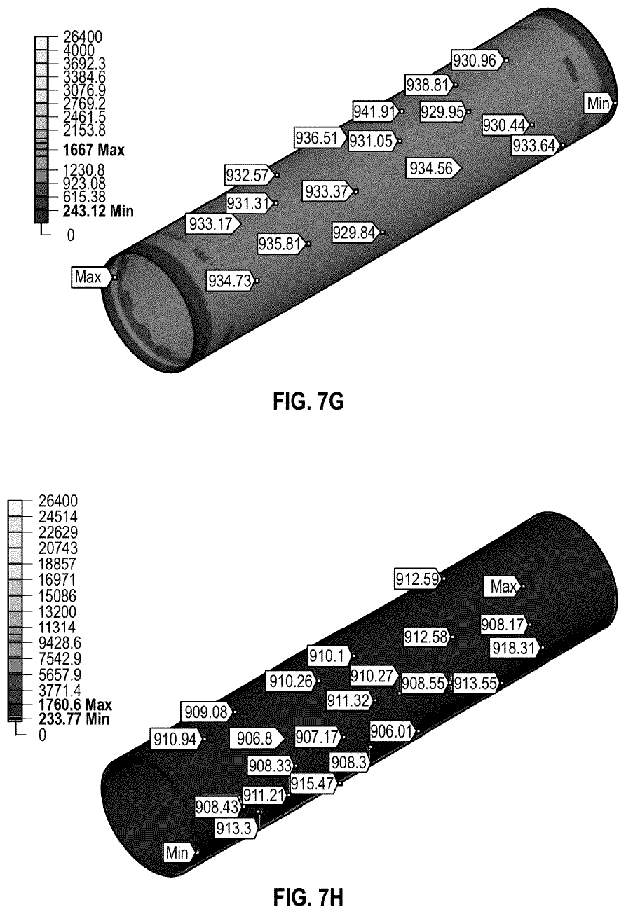

Provided in FIGS. 7A-7H are heat plots depicting sealing layer Von-Mises stress [psi] for winding angles of (a) 50°, (b) 55°, (c) 60°, (d) 65°, (e) 70°, (f) 75°, (g) 80°, and (h) 85°.

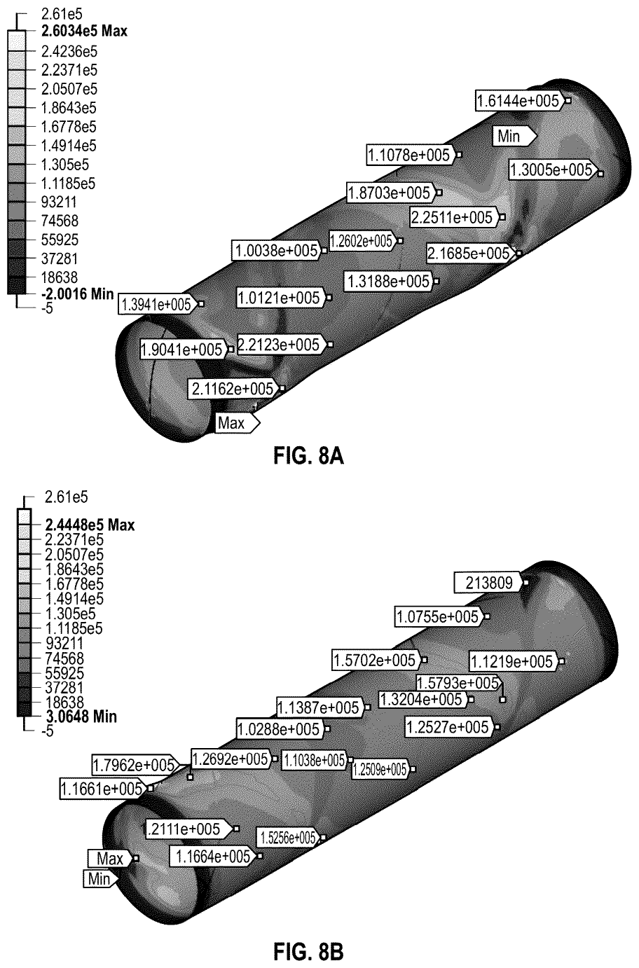

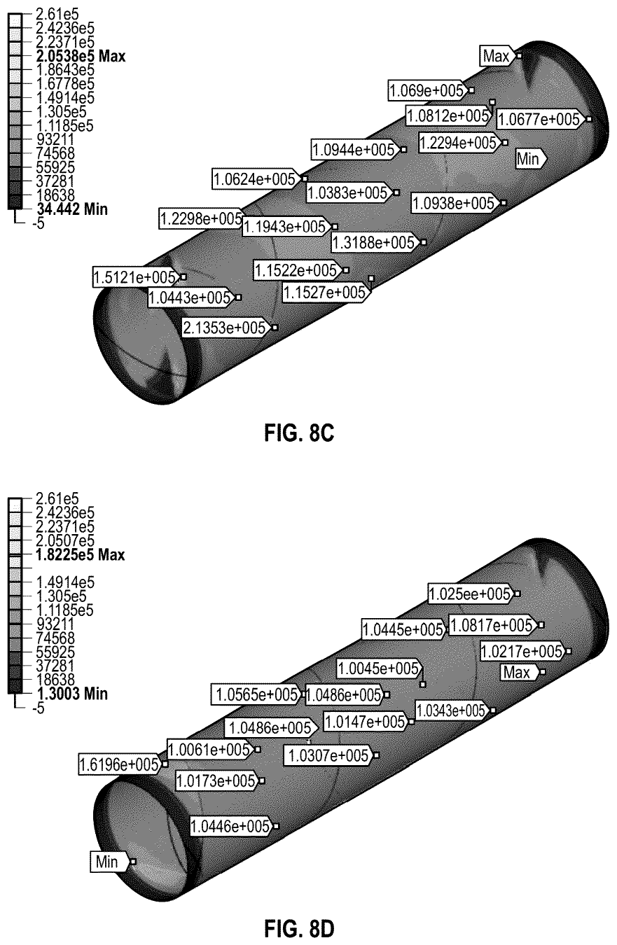

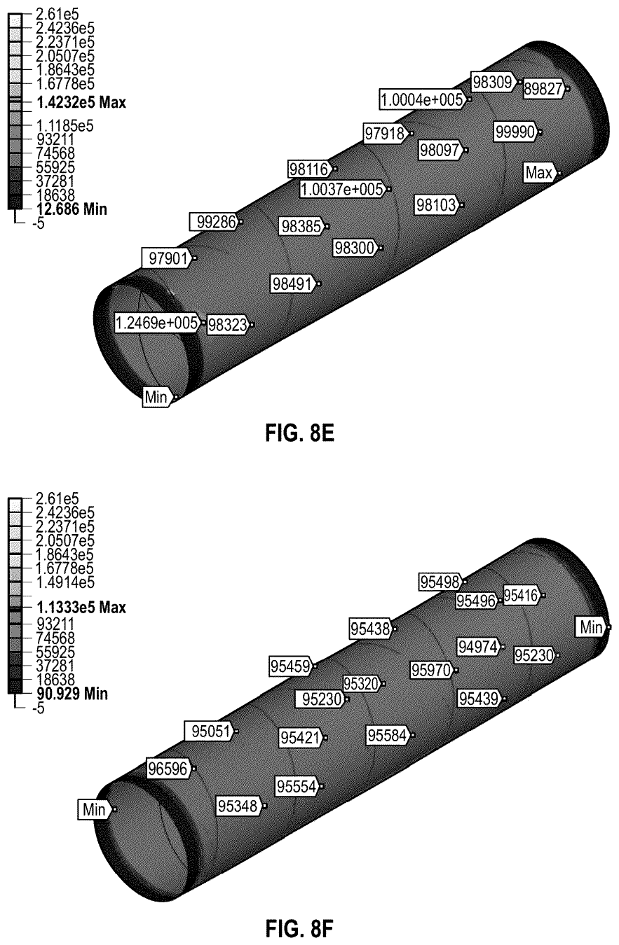

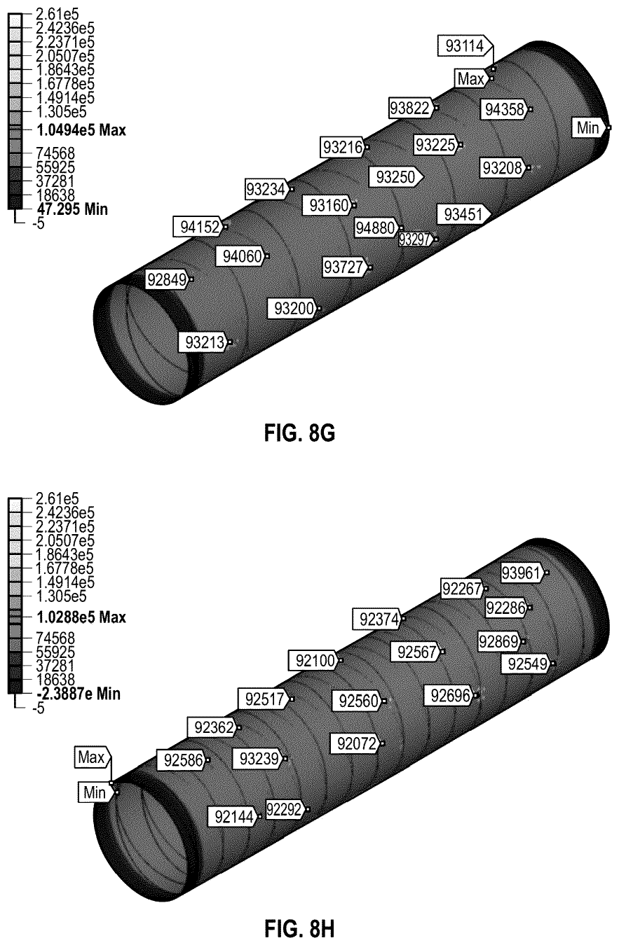

Provided in FIGS. 8A-8H are heat plots depicting fiber maximum principal stress [psi] for winding angles of (a) 50°, (b) 55°, (c) 60°, (d) 65°, (e) 70°, (f) 75°, (g) 80°, and (h) 85°.

The heat plots for the 50° winding angle vessel simulations show that the stress distribution aligns with the deformation pattern observed in the vessel's impact on the sealing/barrier material. At this winding angle, acute deformation is observed, and the fiber reinforcement experiences noticeable distortions due to the high internal pressure. In addition, deformation is non-uniform across the vessel.

Based on the simulation results, an increase in winding angle correlates with an improved hoop stress distribution and reduced stresses on both the tubular barrier material and reinforcement fibers.

Although deformation of the vessel is high for the 50° winding angle, a 5° increase in the winding angle to 55° provides an 80% reduction in deformation. However, the maximum deformation of the vessel at 55° is still approximately 0.36 inches, and localized stresses for both the tubular barrier layer and reinforcement fibers remain relatively high. It should be noted that although the performance of the 55° winding angle vessel is relatively poor, this angle is the most widely used winding angle for contemporary composite vessels using bidirectional fabrics.

As the radial winding angle is increased to 70°, the maximum deformation is reduced by 96% compared to the 55° vessel, and deformation is increasingly more uniform across the entire vessel surface. Finally, at 85° the reduction in deformation is 97.2% compared to the 55° vessel, and deformation is highly uniform across the entire vessel surface.

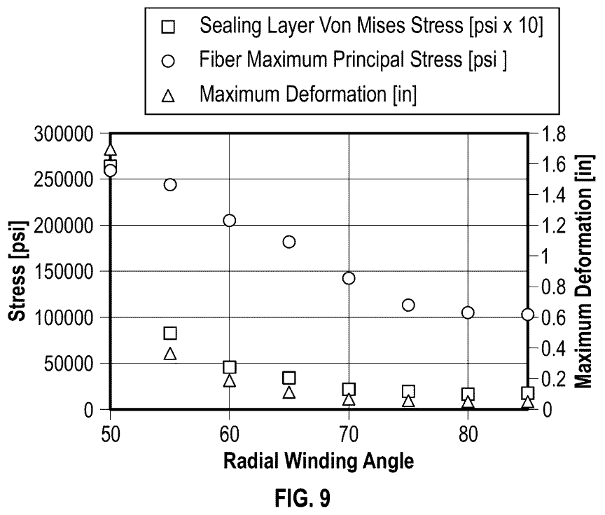

Trends from the simulation result for all evaluated winding angles indicate a significantly non-linear relationship between winding angle and both deformation and stress on the sealing/barrier material. This non-linear relationship can be observed in FIG. 9, which shows the effect of radial winding angle on (a) sealing layer von-Mises stress, (b) fiber maximum principal stress, and (c) maximum deformation. Interestingly, the non-linear relationship between winding angle and fiber maximum principal stress is reduced in comparison to deformation and sealing layer stress, with a more gradual and uniform reduction in fiber stress as winding angle increases.

### EXAMPLE 2

### FEA of Independently Reinforced Vessels. I.

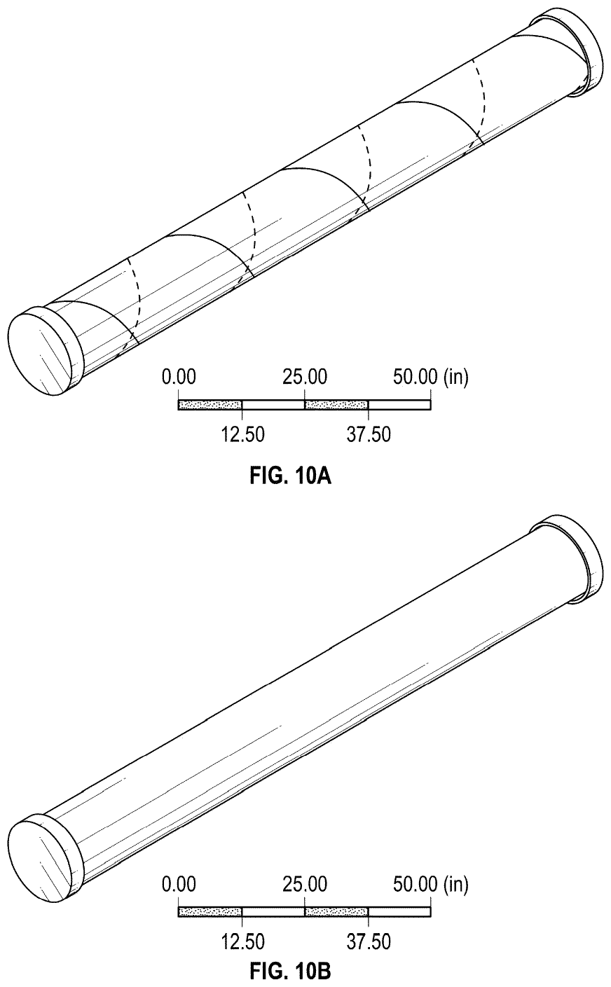

To quantify the performance of a vessel reinforced with independent axial and radial micro-rope, two FEA simulation models were created and are shown in FIGS. 10A and 10B.

The first model, shown in FIG. 10A, was considered a baseline vessel representative of contemporary bidirectional reinforcement and consisted of the application of micro-rope at a winding angle of 57.5°. This angle provides approximately twice the reinforcement strength along the hoop direction as compared to the axial direction, which is a standard strength requirement for composite vessels lacking constraints along the axial direction. The baseline vessel was reinforced with two layers of winding fibers, each with a thickness of 0.063 inches, yielding a total reinforcement thickness of 0.126 inches.

The second model, shown in FIG. 10B, was a vessel with independent axial and radial micro-rope reinforcements sequentially applied. For this model, axial reinforcement thickness was 0.042 inches, and a single layer of reinforcement was applied in the axial direction.

Thereafter, two layers of radial reinforcement were applied at a winding angle of 85°, resulting in an overall reinforcement of 0.126 inches. Therefore, the overall reinforcement thicknesses of both the baseline vessel and the independent reinforcement vessels were equivalent. In addition, for both models the outside diameter and length are 16 inches and 144 inches respectively, and the reinforcement fibers formed continuous layers absent of any gaps above 0.075 inch between tape segments. Boundary conditions of the models consisted of single fixed exterior end, allowing the vessel to elongate in the axial direction when subject to internal pressure. An internal pressure boundary condition of 1500 psi was applied to the interior surfaces of both models. In addition, all components in the model are connected to each other with bonding contacts.

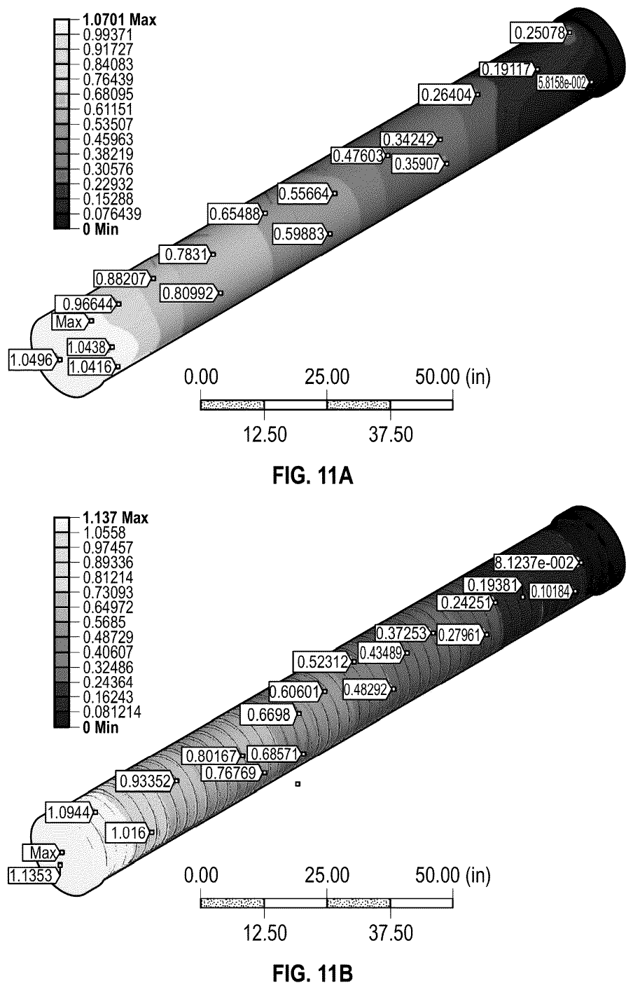

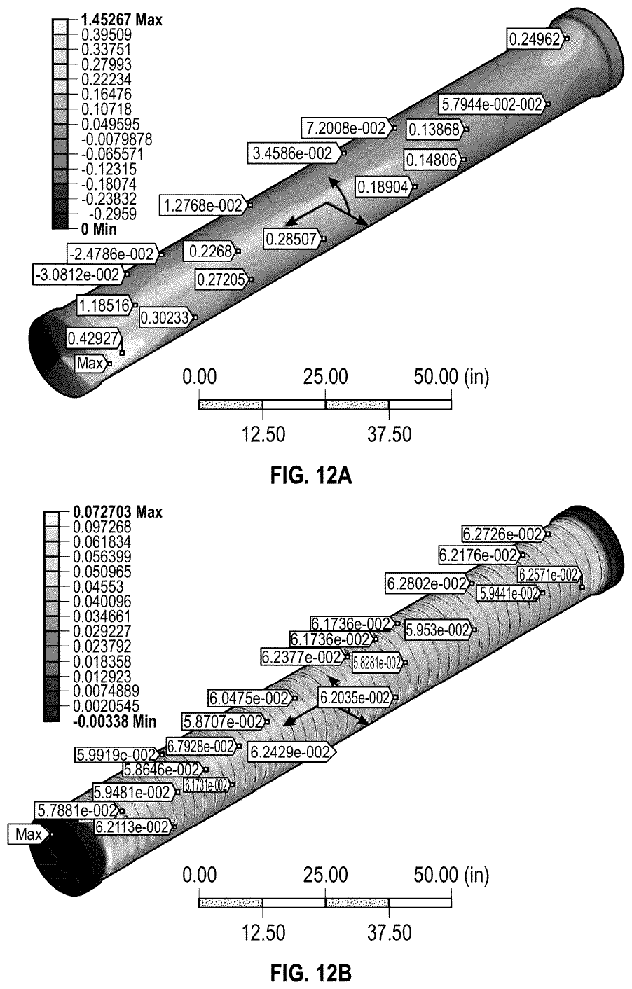

Heat plots showing total deformations and radial deformations of the baseline and independent reinforcement vessel FEA simulations are provided in FIGS. 11A-11B and 12A-12B. For both models, bulk deformation shown in FIG. 11A and FIG. 11B for the baseline simulation and independent reinforcement vessel simulation, occurs uniformly down the axis of the vessel due to the combined axial reinforcement and model constraints, allowing for growth of the vessel due to the pressure condition. However, significant non-uniform deformations occur in the radial direction for the baseline model, shown in FIG. 12A, while no radial deformations occur in the independent reinforcement vessel, shown in FIG. 12B.

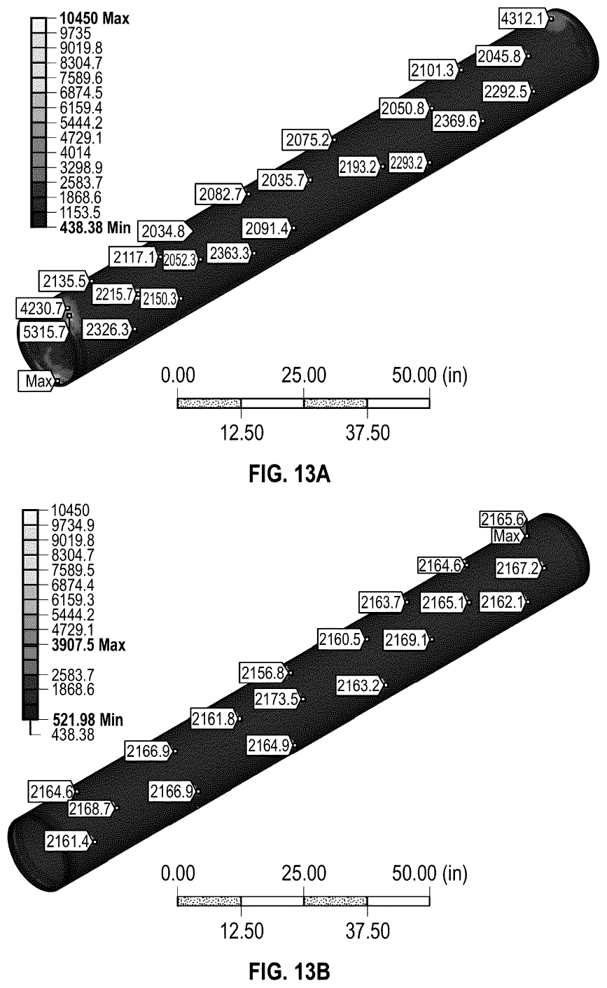

Provided in FIGS. 13A and 13B are heat plots of the von-Mises stress on the sealing layer for the baseline and independent reinforcement vessels, respectively. The baseline vessel sealing layer experiences a peak stress that is 167% higher than that of the independent reinforcement vessel and exhibits significantly higher localized stress variations.

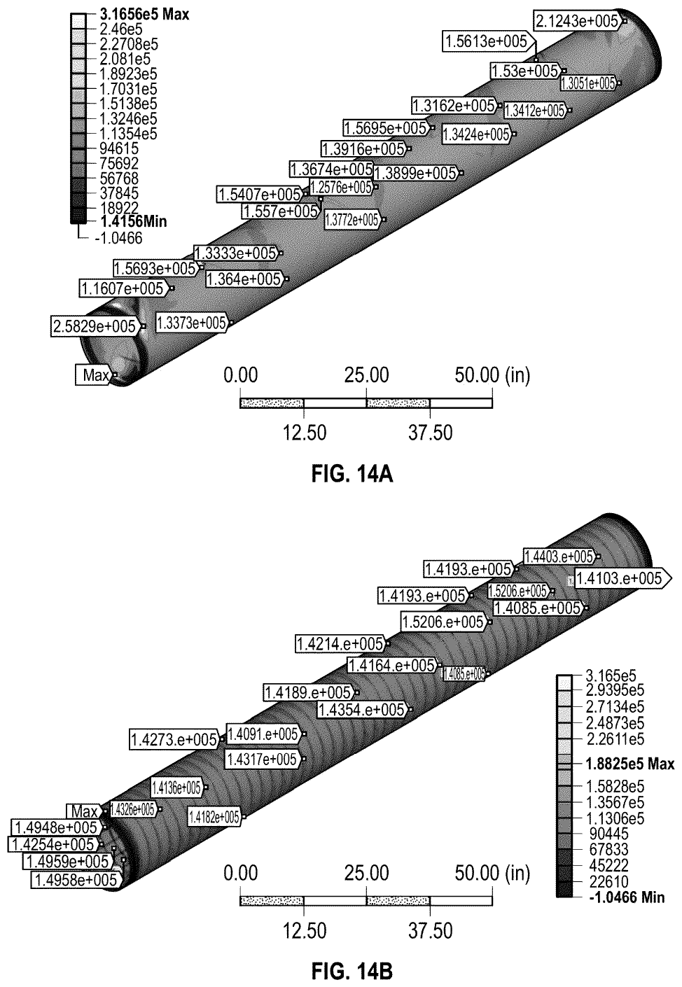

Provided in FIGS. 14A and 14B are heat plots for the maximum principal stress on the reinforcement fiber for the baseline and independent reinforcement vessels, respectively. Similar to the higher stresses on the sealing layer for the baseline vessel, the stresses on the reinforcement for the baseline vessel are much higher than for the independent reinforcement vessel and exhibit significantly higher localized stress variations.

The significant difference in stress magnitudes and distributions between the two simulations provide direct evidence of the performance benefits of the independent axial and radial reinforcement method and their alleviation of stress on the sealing layer.

### EXAMPLE 3

### FEA of Independently Reinforced Vessels. II.

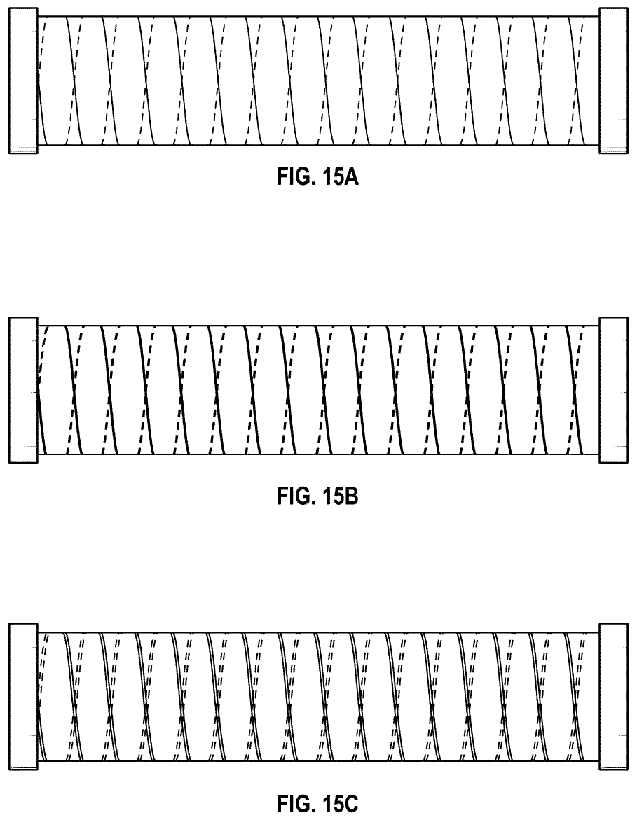

Variations in the composite vessel reinforcement application process can be caused by many factors, including mechanical vibration, linear speed changes, and the initiation or conclusion of reinforcement rolls. These variations can lead to imperfections such as gaps and overlaps in the reinforcement layers. Additionally, the design calculus and considerations for the pressure rating of composite vessels direct the exact design, angle, spacing and orientation of these reinforcements along the axis of the tubular barrier material. Three composite pipes, depicted in FIGS. 15A-15C, with the same fiber width but different gaps between fibers were simulated through FEA. The first pipe, depicted in FIG. 15A, has a fiber gap of 0.012″, the second pipe, depicted in FIG. 15B, has a fiber gap of 0.125″, and the third pipe, depicted in FIG. 15C, has a fiber gap of 0.25″.

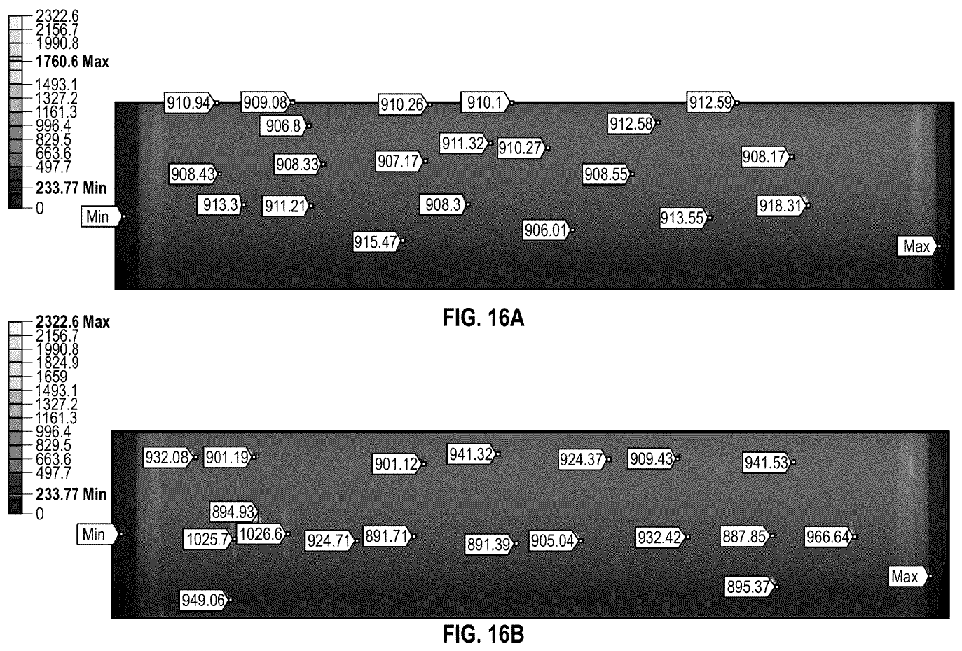

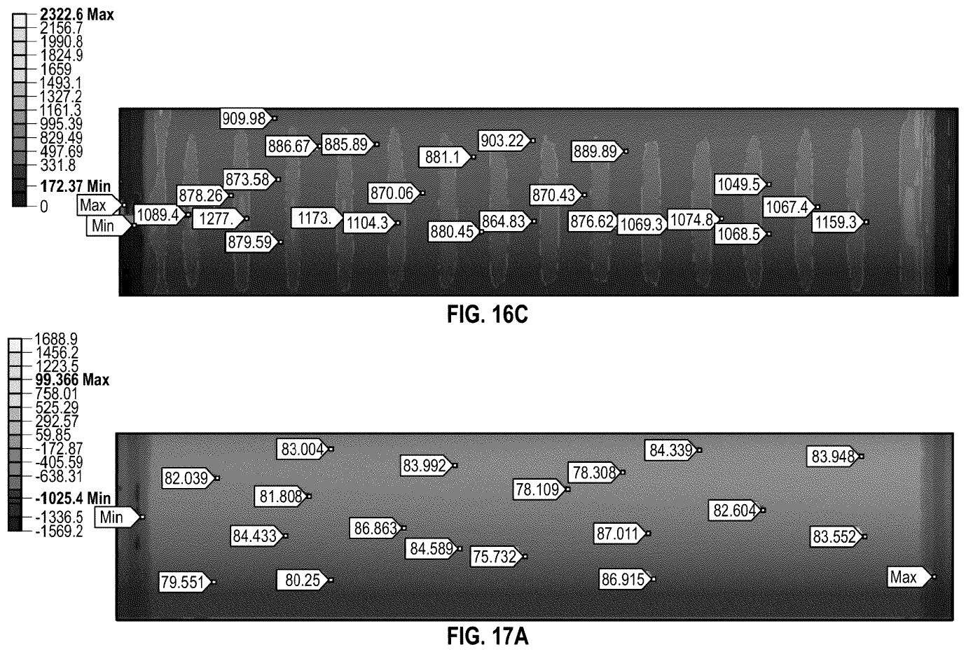

Provided in FIGS. 16A-16C are heat plots of equivalent stress for the three composite pipes.

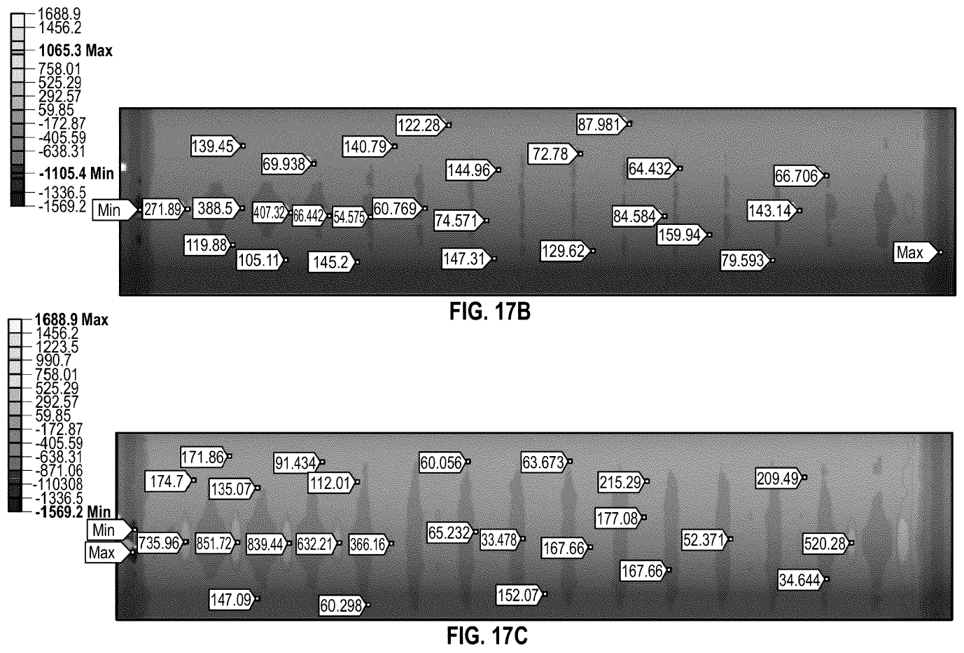

Provided in FIGS. 17A-C are heat plots of maximum principal stress results for the three composite pipes.

The results show that the fiber gap can effectively influence the stress on the sealing material in the areas that are not reinforced by the fibers. An increased fiber gap distance can dramatically increase the stress on the sealing material, especially the maximum principal stress. In these high gap conditions, the uncovered tubular barrier material will be at high-risk for failure.

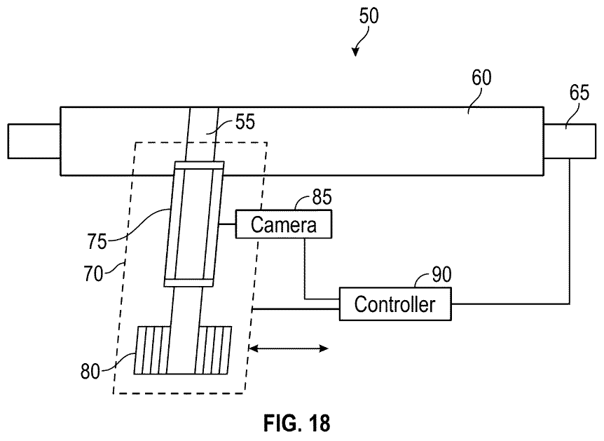

The simulation results confirm that there is a high sensitivity of fiber reinforcement performance to application reliability. In addition, the significant value of independent axial and radial reinforcement creates the need for quality control of two independent application steps. The need for quality control is further elevated for composite vessel applications in flammable gas applications such as hydrogen transmission and storage to mitigate the risk of potential failure events. For these reasons, according to an aspect of the disclosed concept, a novel computer vision system 50 as shown in FIG. 18 has been implemented for reinforcement application quality assurance when applying a fiber reinforcement element 55, such as micro-rope tape as described herein, to a vessel 60 provided on a winder 65.

As seen in FIG. 18, the novel computer vision system 50 employs a movable (both laterally and pivotably under the control of controller 90 to allow the application of fiber reinforcement element 55 to be varied as described herein) reinforcement application apparatus 70 that includes a fiber reinforcement element applicator 75, a source 80 of fiber reinforcement element 55, a high-resolution video camera 85 mounted on the applicator 75 or the winder 65, and a controller 90 coupled to the reinforcement application apparatus 70, the winder 65 and the camera 85. Alternatively, winder 65 may be moveable (under the control of controller 90) both laterally and pivotably to allow the application of fiber reinforcement element 55 to be varied as described herein). Controller 90 comprises a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory. The program code is configured to implement the control functionality for computer vision system 50 described below.

Camera 85 is configured for capturing detailed images of the composite vessel 60 as fiber reinforcement element 55 is applied. These images are then analyzed in controller 90 using the advanced object detection algorithm YOLO (You Only Look Once) segmentation version 8 algorithm to generate regions of interest in the images that are then further evaluated. Due to the relatively light computational requirements of the computer vision method, computer vision system 50 is able to be operated in real-time to monitor the axial and radial application of fiber reinforcement element 55 on the cylindrical sealing layer of vessel 60. The fiber reinforcement element 55 is applied in successive layers, including axial, radial, and contra-radial orientations to develop the structural integrity and performance of the composite vessel.

The computer vision model of controller 90 is trained to identify specific types of errors for the manufacturing process including axial, radial, and contra-radial gaps and overlaps. The algorithm quantifies reinforcement gap size and if the value exceeds the compliant condition, corrective commands are generated for controlling reinforcement application apparatus 70 and/or winder 65. These commands are sent to controlling reinforcement application apparatus 70 and/or winder 65, adjusting the reinforcement application processes in real time to correct the identified imperfections and remain within specifications. This feedback loop ensures that the reinforcement is applied with precise alignment and orientation, directly correlating to meeting or exceeding the structural strength as required by the vessels design. The computer vision model and associated controls represent a significant innovation in the field of manufacturing quality assurance and control (QA/QC) for pipeline production and energy storage applications. Novel Aspects of the computer vision model include:

1. Real-Time Error Correction: The ability to detect and correct fiber reinforcement application errors in real-time, with a detection speed of less than 7 milliseconds, providing corrective response to ensure manufacturing continuously remains within design specifications.

2. Precision and Consistency in Reinforcement Appointment: By ensuring the precise appointment of micro-rope fibers to the vessel sealing layer, the system significantly increases the structural strength of the final product. The consistent orientation and pitch of the fibers, as maintained by the vision system, contribute to the uniformity and integrity of the reinforcement, distinguishing it from conventional methods such as bi-directional fabric windings, that may exhibit variability in fiber placement.

3. Energy Efficiency: The vision system is designed to be computationally light-weight and energy-efficient, making it suitable for deployment on resource-constrained processors commonly used in industrial environments.

4. Advanced Object Detection: The application of YOLO v8 for the generation of regions of interest within images and the subsequent gap size quantification for composite pipe reinforcement is a novel approach. Performance of the segmentation and region of interest algorithm is high due to the broad set of training data used to construct the algorithm for a range of applications.

While the methods and manufactures have described in detail and with reference to specific examples thereof, it will be apparent to one skilled in the art that various changes and modifications can be made therein without departing from the spirit and scope thereof.

What is claimed is:

1. A tubular composite for storing and/or transporting a gas, comprising:
a tubular sealing/barrier layer for forming a gas diffusion resistant containment for the gas; and
a helical overwrap coupled to the tubular layer, wherein the helical overwrap comprises a reinforcement element wrapped about the tubular layer at a winding angle with respect to a longitudinal axis of the tubular layer that is greater than or equal to 70°.

2. The tubular composite of claim 1, wherein the winding angle is greater than or equal to 75°.

3. The tubular composite of claim 2, wherein the winding angle is greater than or equal to 80°.

4. The tubular composite of claim 3, wherein the winding angle is greater than or equal to 85°.

5. The tubular composite of claim 1, wherein the overwrap comprises a plurality of helically oriented strips.

6. The tubular composite of claim 5, wherein at least 90% of the strips in the overwrap do not overlap.

7. The tubular composite of claim 5, wherein a plurality of the strips in the overwrap do not overlap, and wherein a median gap between non-overlapping strips in the overwrap is 0.5 inches or less.

8. The tubular composite of claim 1, wherein the reinforcement element comprises a reinforcement tape.

9. The tubular composite of claim 8, wherein the reinforcement tape is twisted fiber micro-rope tape.

10. The tubular composite of claim 9, wherein the twisted fiber micro-rope tape compromises a plurality of twisted fiber tows bound into tape form.

11. The tubular composite of claim 10, wherein the twisted fiber tows are twisted carbon fiber tows.

12. The tubular composite of claim 10, wherein the twisted fiber tows are bound into tape form using polyethylene.

13. The tubular composite of claim 12, wherein the twisted fiber tows are impregnated with polyethylene and twisted into a rounded rope under torsion.

14. The tubular composite of claim 1, further comprising a second overwrap coupled to the tubular layer, wherein the second overwrap comprises a plurality of strips of reinforcing material, wherein each strip is oriented such that a longitudinal axis of the strip is along the longitudinal axis of the tubular layer.

15. The tubular composite of claim 14, wherein the second overwrap is provided in between the tubular layer and the overwrap.

16. The tubular composite of claim 9, further comprising a second overwrap coupled to the tubular layer, wherein the second overwrap comprises a plurality of strips of reinforcing material, wherein each strip is oriented such that a longitudinal axis of the strip is along the longitudinal axis of the tubular layer, and wherein each strip is a twisted fiber micro-rope tape.

17. A method of fabricating a tubular composite for storing and/or transporting a gas, comprising:
providing a tubular sealing/barrier layer for forming a gas diffusion resistant containment for the gas; and
coupling a helical overwrap to the tubular layer by wrapping a reinforcement element about the tubular layer at a winding angle with respect to a longitudinal axis of the tubular layer that is greater than or equal to 70°.

18. The method of claim 17, wherein the winding angle is greater than or equal to 75°.

19. The method of claim 18, wherein the winding angle is greater than or equal to 80°.

20. The method of claim 19, wherein the winding angle is greater than or equal to 85°.

21. The method of claim 18, wherein the overwrap comprises a plurality of helically oriented strips.

22. The method of claim 21, wherein at least 90% of the strips in the overwrap do not overlap.

23. The method of claim 21, wherein a plurality of the strips in the overwrap do not overlap, and wherein a median gap between non-overlapping strips in the overwrap is 0.5 inches or less.

24. The method of claim 18, wherein the reinforcement element comprises a reinforcement tape.

25. The method of claim 24, wherein the reinforcement tape is twisted fiber micro-rope tape.

26. The method of claim 25, wherein the twisted fiber micro-rope tape compromises a plurality of twisted fiber tows bound into tape form.

27. The method of claim 26, wherein the twisted fiber tows are twisted carbon fiber tows.

28. The method of claim 26, wherein the twisted fiber tows are bound into tape form using polyethylene.

29. The method of claim 28, wherein the twisted fiber tows are impregnated with polyethylene and twisted into a rounded rope under torsion.

30. The method of claim 18, further comprising coupling a second overwrap to the tubular layer by coupling a plurality of strips of reinforcing material to the tubular, wherein each strip is oriented such that a longitudinal axis of the strip is along the longitudinal axis of the tubular layer.

31. The method of claim 30, wherein the second overwrap is provided in between the tubular layer and the overwrap.

32. The method of claim 25, further comprising coupling a second overwrap to the tubular layer by coupling a plurality of strips of reinforcing material to the tubular, wherein each strip is oriented such that a longitudinal axis of the strip is along the longitudinal axis of the tubular layer, and wherein each strip is a twisted fiber micro-rope tape.

33. The method of claim 18, further comprising capturing images of the overwrap as the reinforcement element is being wrapped about the tubular layer, and analyzing the images in a controller, and adjusting the winding angle and/or an axial spacing of the reinforcement element as it is wrapped about the tubular layer based on the analysis of the images.

34. The method according to claim 33, wherein the controller implements a computer vision model for performing the analyzing.

35. The method according to claim 34, wherein the computer vision model comprises an object detection and image segmentation model.

36. The method according to claim 33, wherein the analyzing includes identifying gaps and/or overlaps in the overwrap.

37. The method according to claim 36, wherein the analyzing quantifies identified gasps and adjusts the winding angle and/or the axial spacing of the reinforcement element if a quantified gaps exceeds a predetermined level.

38. The method according to claim 33, wherein the tubular composite is provided on a winder, wherein the reinforcement element is provided from an applicator apparatus, and wherein the adjusting the winding angle and/or the axial spacing comprises adjusting the winder, the applicator apparatus or both the winder and the applicator apparatus.

39. A system for fabricating a tubular composite for storing and/or transporting a gas, comprising:
a winder for rotating a tubular sealing/barrier layer of the tubular composite for forming a gas diffusion resistant containment for the gas;
an applicator apparatus for coupling a helical overwrap to the tubular layer, wherein the reinforcement element is wrapped about the tubular layer at a winding angle with respect to a longitudinal axis of the tubular layer;
a camera for capturing images of the overwrap as the reinforcement element is being wrapped about the tubular layer; and
a controller structured and configured for analyzing the images and controlling the winder, the applicator apparatus or both the winder and the applicator apparatus to adjust the winding angle and/or an axial spacing of the reinforcement element as it is wrapped about the tubular layer based on the analysis of the images.

40. The system according to claim 39, wherein the controller implements a computer vision model for performing the analyzing.

41. The system according to claim 40, wherein the computer vision model comprises an object detection and image segmentation model.

42. The system according to claim 39, wherein the analyzing includes identifying gaps and/or overlaps in the overwrap.

43. The system according to claim 42, wherein the analyzing quantifies identified gasps and wherein the controller adjusts the winding angle and/or the axial spacing of the reinforcement element if a quantified gaps exceeds a predetermined level.

44. The system according to claim 39, wherein the reinforcement element comprises a twisted fiber micro-rope tape.

45. The tubular composite of claim 1, wherein the sealing/barrier layer comprises medium density polyethylene (MDPE), high density polyethylene (HDPE), a polyaramid (PA), or aluminum.

46. The tubular composite of claim 1, wherein the sealing/barrier layer comprises a gas diffusion resistant polymer layered coextrusion.

47. The tubular composite of claim 46, wherein the sealing/barrier layer comprises a hydrogen diffusion resistant polymer layered coextrusion.

48. The method of claim 17, wherein the sealing/barrier layer comprises medium density polyethylene (MDPE), high density polyethylene (HDPE), a polyaramid (PA), or aluminum.

49. The method of claim 17, wherein the sealing/barrier layer comprises a gas diffusion resistant polymer layered coextrusion.

50. The method of claim 49, wherein the sealing/barrier layer comprises a hydrogen diffusion resistant polymer layered coextrusion.
